(19) United States
(12) Patent Application Publication
(10) Pub. No.: US 2020/0261991 A1
(43) Pub. Date: Aug. 20, 2020

(54) AN ENGINE-DRIVEN TOOL WITH A GENERATOR CONNECTED TO A FAN MOTOR

(71) Applicant: HUSQVARNA AB, HUSKVARNA (SE)

(72) Inventor: Fredrik Karlsson, Sävedalen (SE)

(21) Appl. No.: 16/347,324

(22) PCT Filed: Oct. 25, 2017
(86) PCT No.: PCT/SE2017/051050

§ 371 Date: May 3, 2019

(30) Foreign Application Priority Data
Nov. 3, 2016 (SE) 1651452-3

(51) Int. Cl. B23D 47/12; B23D 45/16; B23D 59/00; B23Q 11/02

(52) U.S. Cl. CPC B23D 47/12; B23Q 11/02; B23D 59/006; B23D 45/16

(57) ABSTRACT

The present disclosure relates to an engine-driven tool (1) comprising a rotatable work tool (2), an engine (4) that is arranged to propel the rotatable work tool (2), a shielding cover (8) for shielding the rotatable work tool (2), and a dust channel (11) that is formed between the shielding cover (8) and the rotatable work tool (2). A dust hose (14) is arranged to connect the dust channel (11) to a dust container (17) and an electrically driven fan (16) that is arranged to convey air from the dust channel (11) into the dust container (17) via the dust hose (14). The engine-driven tool (1) comprises an electrical generator (18) that is electrically connectable to the fan motor (26) and is arranged to be at least indirectly driven by the engine (4). The electrical generator (18) is furthermore arranged to generate an electrical current when driven, where said electrical current at least indirectly is arranged to propel the fan motor (26).

### TECHNICAL FIELD

The present disclosure relates to an engine-driven tool comprising a rotatable work tool, an engine that is arranged to propel the rotatable work tool, a shielding cover that is arranged to shield a part of the rotatable work tool, and a dust channel that is formed between the shielding cover and the rotatable work tool. A dust hose is arranged to at least indirectly connect the dust channel to a dust container and an electrically driven fan that is arranged to convey air from the dust channel into the dust container.

### BACKGROUND

Many motor tools such as engine-driven handheld cutting machines have saw blades which may be circular or ring-shaped. Such a cutting machine may be used for cutting hard materials such as concrete or rock, where the cutting procedure may result in the creation of dust. For example concrete dust is unhealthy to breathe and also impairs visions, and it is desired to minimize the creations of such dust that freely may expand in the air. Such free concrete dust that finds its way into the engine of the tool drastically affects the engine in a negative way, may cause undesirable health effects and generally pollutes the environment.

Many tools of the above type or for this purpose equipped with a water supply, where a flow of water is directed towards the saw blade in such a way that a large quantity of the dust is mixed with the water and thus retained and kept from expanding in the air.

The flow of water is preferably held at a minimum while maintaining a proper function, since the water normally has to be taken care of at the working site, more water than necessary is undesirable. At some working sites, a demand for cleanliness, or shortage of water, results in that such a water supply is undesired. For this purpose, many types of dust removal systems of vacuum cleaner type have been developed. Some of them have an integrated fan motor for propelling air into a dust hose that guides undesired dust particles to a remote dust container. Others have an electrical fan motor positioned at such a remote dust container, where the fan motor then is connected to a suitable power outlet.

There is, however, a desire for a less complicated and versatile dust removal arrangement for an engine-driven tool such as a power cutter.

### SUMMARY

The object of the present disclosure is to provide a dust removal arrangement for an engine-driven tool that is less complicated and versatile compared to prior art.

This object is achieved by means of an engine-driven tool comprising a rotatable work tool, an engine that is arranged to propel the rotatable work tool, a shielding cover that is arranged to shield a part of the rotatable work tool, and a dust channel that is formed between the shielding cover and the rotatable work tool. A dust hose is arranged to at least indirectly connect the dust channel to a dust container and an electrically driven fan which comprises a fan motor. The electrically driven fan is arranged to convey air from the dust channel into the dust container via the dust hose. The engine-driven tool furthermore comprises an electrical generator that is at least indirectly electrically connectable to the fan motor and is arranged to be at least indirectly driven by the engine. The electrical generator is furthermore arranged to generate an electrical current when driven, where said electrical current at least indirectly is arranged to propel the fan motor.

According to an example, the engine-driven tool comprises an electrical conductor arrangement that is arranged to at least indirectly connect the electrical generator to the fan motor.

According to another example, the electrical conductor arrangement is partly running inside the dust hose.

According to another example, the electrical conductor arrangement is releasably connectable to the electrical generator and/or the electrically driven fan.

According to another example, the electrical generator comprises circumferentially arranged coils and is co-axially arranged with an engine flywheel that comprises at least one circumferentially running magnet. The engine flywheel is arranged to spin while the electrical generator is fixed in relation to an engine flywheel such that the magnets spin past the coils when the engine flywheel is rotating.

According to another example, the engine-driven tool comprises a power transferring means that is arranged to connect the rotatable work tool to the engine. The electrical generator is suitably arranged to be propelled by the power transferring means.

Other examples are disclosed in the dependent claims.

A number of advantages are obtained by means of the present disclosure. Mainly, the power cutter does not have to be equipped with an integrated fan for dust removal, and the electrically driven fan does not need a separate power source. This results in a tool with reduced weight that thus is easy to handle.

### BRIEF DESCRIPTION OF THE DRAWINGS

The present disclosure will now be described more in detail with reference to the appended drawings, where:

FIG. 1 shows a perspective view of a hand-held power cutter;

FIG. 2A shows a partially cut-open view of a part of the power cutter without an engine flywheel; and

FIG. 2B shows the engine flywheel and an electrical generator.

### DETAILED DESCRIPTION

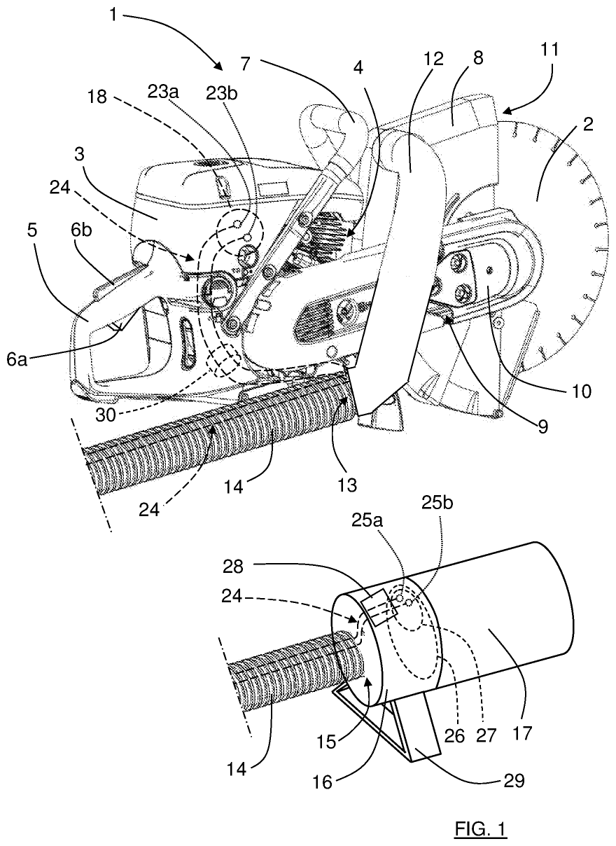

With reference to FIG. 1, there is a hand-held power cutter 1 with a circularly shaped saw blade 2, for example suitable to cut through concrete. The power cutter 1 comprises a casing 3 at least partly enclosing a combustion engine 4, where the casing 3 in turn comprises a first handle part 5 from which a power/throttle switch 6a and corresponding switch lock 6b is accessible. The power cutter 1 further comprises a second handle part 7 that runs in an arcuate shape over the casing 3, the second handle part 7 being attached to the casing 3 via means that attenuate vibrations in a well-known manner.

The power cutter 1 comprises a shielding cover 8 that is arranged to shield a part of the saw blade 2. The saw blade 2 is connected to the engine 4 with a power transferring means 9 that is covered by a power transfer cover 10. The power transferring means 9 is according to some aspects either in the form of an endless belt or a geared transmission.

A dust channel 11 is formed between the shielding cover 8 and the saw blade 2, where a dust pipe 12 is connected between an upper part of the shielding cover 8 and a first hose end 13 of a dust hose 14. A second hose end 15 of the dust hose 14 is connected to a dust container 17 and an electrically driven fan 16 that is arranged to lower the air pressure at the second hose end 15 such that air is conveyed from the first hose end 13 to the second hose end 15 and further into the dust container 17 via the fan 16, such that an operation that is similar or the same as the operation of a vacuum cleaner is obtained. When the power cutter 1 is in operation and the saw blade 2 for example is cutting through concrete, a lot of concrete dust is formed. By means of the fan 16 and the dust hose 14, the concrete dust is conveyed from the dust channel 11 in the shielding cover 8 to the dust container 17. It is to be noted that the fan 16 and the dust container 17 only are schematically indicated for describing a principle, not being shown in actual sizes and configurations.

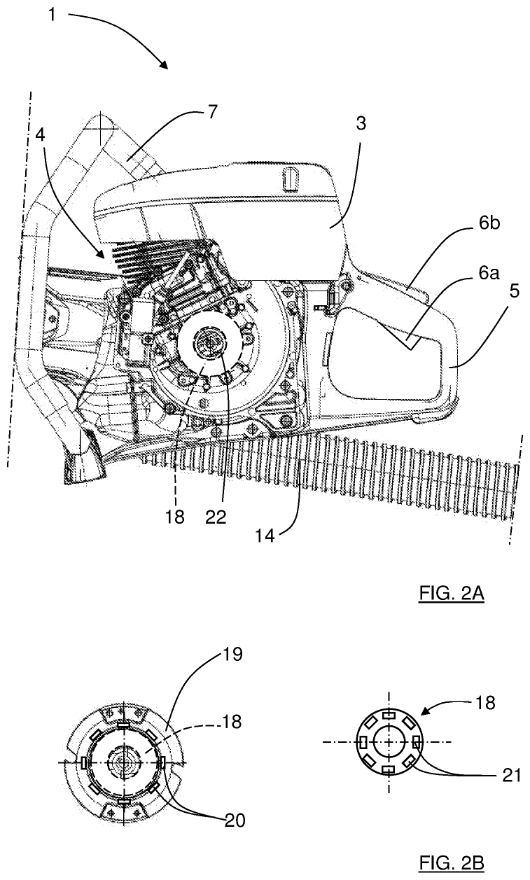

According to the present disclosure, with reference also to FIG. 2A and FIG. 2B, the power cutter 1 comprises an electrical generator 18 that is at least indirectly electrically connected to the fan motor 26 and is arranged to be at least indirectly driven by the engine 4 and to generate an electrical current when driven. Said electrical current is at least indirectly arranged to propel the fan motor 26.

FIG. 1 shows the electrical generator 18 schematically indicated with dashed lines, FIG. 2A shows a partially cut-open view of a part of the power cutter 1 without an engine flywheel 19 but with the electrical generator 18 schematically indicated with dashed lines, According to some aspects, the generator 18 is positioned inside the flywheel 19 and is attached in a fixed manner to a crank case (not shown), for example by means of screws. FIG. 2B shows the engine flywheel 19 together with the electrical generator 18 only schematically indicated with dashed lines, as well as separately.

The electrical generator 18 is arranged to be mounted such that it is fixed in relation to an engine flywheel 19 as will be described in detail below. The engine flywheel 19 comprises circumferentially running magnets 20 (only a few indicated for reasons of clarity) and the electrical generator 18 comprises circumferentially running coils 21 (only a few indicated for reasons of clarity). Generally, the engine flywheel 19 comprises at least one circumferentially running magnet.

The flywheel 19 is arranged to be mounted to an engine axis 22 such that when the engine is running, the flywheel is spinning while the electrical generator 18 is fixed in relation to an engine flywheel 19. As indicated in FIG. 2B, the electrical generator and the flywheel are co-axially arranged, such that the magnets 20 spin past the coils 21 such that an electrical current is induced and is available at generator terminals 23. An electrical conductor arrangement 24 is connected to the generator terminals 23 and runs to fan motor terminals 25a, 25b at the fan motor 26 schematically indicated in FIG. 1.

In this way, electrical power that is generated by the electrical generator 18 is used for propelling the fan motor 26. Due to the type of fan motor 26 that is used in the fan 16, a power conversion device 27 may be needed and could for example be comprised in the fan 16 or between the electrical generator 16 and the first hose end 13 along the electrical conductor arrangement 24. In FIG. 1, a power conversion device 27 is positioned at the fan motor terminals 25a, 25b, being arranged to convert the incoming electrical current to a format suitable for the fan motor 26. Such a power conversion device 27 could be an alternating current (AC) to direct current (DC) converter device or a frequency period time converter device. It is to be noted, that due to the type of fan motor 26, a power conversion device 27 does not have to be used.

This means that when the power cutter engine 4 is run, the electrical generator 18 is also run. The electrical generator 18 is electrically connected to the electrically driven fan 16, such that the power cutter engine 4 is arranged to run the electrical generator 18, and when electrical current is generated by the electrical generator 18, said electrical current can be used for running the electrically driven fan 16 via the electrical conductor arrangement 24.

In this manner, the power cutter does not have to be equipped with an integrated fan for dust removal, and the electrically driven fan 16 does not need a separate power source, but acquires its required electrical power from the electrical generator 18 that is comprised in the power cutter 1.

In this example, the electrical conductor arrangement 24 is shown to be running inside the dust hose 14. According to some aspects, the electrical conductor arrangement 24 is running outside the dust hose 14; either attached to the outer surface of the dust hose 14 or separate from the dust hose 14.

According to some aspects, the conductor arrangement 24 is releasably connectable to the electrical generator 18 and/or the electrically driven fan 16, for example by means of a corresponding electrical connector at a suitable position, as schematically indicated with dashed lines in FIG. 1 where an electrical connector 30 is positioned at the casing. A corresponding electrical connector can be mounted electrically driven fan 16 as well. Such electrical connectors suitably comprises an environment protection; and are according to some aspects screw-mounted.

The present disclosure is not limited to the above examples, but may vary freely within the scope of the appended claims. For example, the electrical generator 18 may be positioned at any other rotating part and is at least indirectly driven by the engine 4. According to some aspects, the electrical generator 18 is connected to, and arranged to be propelled by the power transferring means 9, such as a drive belt. According to some aspects, the electrical generator 18 is at least partly comprised in a clutch wheel that is arranged to drive a drive belt, or alternatively at least partly comprised in a belt wheel that is connected to the saw blade 2.

The number of coils and magnets shown in the Figures is only an example for describing a principle; there may of course be any suitable number of coils and any suitable number of magnets.

The electrical generator 18 is according to some aspects at least partly made in a plastic material that constitutes an insulator and provides a low weight for the electrical generator 18.

The hand-held power cutter 1 with a circular saw blade 2 may be any type of engine-driven tool with a rotatable work tool such as a saw blade, a circular saw blade or a ring saw blade, where dust removal is desired. Only some items of the engine-driven tool in the example have been described, the engine-driven tool in itself being of a well-known kind.

The dust hose 14 is arranged to connect the dust channel 11 to the dust container 17 via the dust pipe 12. The dust hose 14 is according to some aspects directly connected to the shielding cover 8 and the dust channel 11.

The fan 16 is shown positioned between the second hose end 15 and the dust container 17, and is shown to be supported by a stand 29. The fan may have other positions downstream the second hose end 15. For example, the dust container 17 can be positioned between the fan 16 and the dust hose 14.

The electrical conductor arrangement 24 may comprise two or more conductor wires depending on number of phases, the possible presence of a ground connection, possible data communication wires.

The fan 16 is suitably equipped with a switch 28 for turning on or turning off the fan 16. Such a switch 28 may be positioned anywhere along the electrical conductor arrangement 24; in FIG. 1 the switch is shown positioned at the dust container 17.

According to some aspects, the dust container 17 comprises dust bags which are replaced when filled with dust to a sufficient extent.

Generally, the present disclosure relates to an engine-driven tool 1 comprising a rotatable work tool 2, an engine 4 that is arranged to propel the rotatable work tool 2, a shielding cover 8 that is arranged to shield a part of the rotatable work tool 2, and a dust channel 11 that is formed between the shielding cover 8 and the rotatable work tool 2, where a dust hose 14 is arranged to at least indirectly connect the dust channel 11 to a dust container 17 and an electrically driven fan 16 which comprises a fan motor 26, where the electrically driven fan 16 is arranged to convey air from the dust channel 11 into the dust container 17 via the dust hose 14. The engine-driven tool 1 comprises an electrical generator 18 that is at least indirectly electrically connectable to the fan motor 26 and is arranged to be at least indirectly driven by the engine 4, where the electrical generator 18 furthermore is arranged to generate an electrical current when driven, where said electrical current at least indirectly is arranged to propel the fan motor 26.

According to an example, the engine-driven tool 1 comprises an electrical conductor arrangement 24 that is arranged to at least indirectly connect the electrical generator 18 to the fan motor 26.

According to an example, the electrical conductor arrangement 24 partly is running inside the dust hose 14.

According to an example, the electrical conductor arrangement 24 is releasably connectable to the electrical generator 18 and/or the electrically driven fan 16.

According to an example, the electrical conductor arrangement 24 is releasably connectable by means of at least one screw-mounted electrical connector 30.

According to an example, the engine-driven tool 1 comprises a power transferring means 9 that is arranged to connect the rotatable work tool 2 to the engine 4.

According to an example, the engine-driven tool 1 comprises a dust pipe 12 that is connected between an upper part of the shielding cover 8 and a first hose end 13 of the dust hose 14, where the dust pipe 12 is arranged to extend over the power transferring means 9.

According to an example, the electrical generator 18 comprises circumferentially arranged coils and is co-axially arranged with an engine flywheel 19 that comprises at least one circumferentially running magnet 20, where the engine flywheel 19 is arranged to spin while the electrical generator 18 is fixed in relation to an engine flywheel 19 such that the magnets 20 spin past the coils 21 when the engine flywheel 19 is rotating.

According to an example, the electrical generator 18 is arranged to be propelled by the power transferring means 9.

1. An engine-driven tool comprising a rotatable work tool, an engine that is arranged to propel the rotatable work tool, a shielding cover that is arranged to shield a part of the rotatable work tool, and a dust channel that is formed between the shielding cover and the rotatable work tool, wherein a dust hose is arranged to at least indirectly connect the dust channel to a dust container and an electrically driven fan which comprises a fan motor, wherein the electrically driven fan is arranged to convey air from the dust channel into the dust container via the dust hose, wherein the engine-driven tool comprises an electrical generator that is at least indirectly electrically connectable to the fan motor and is arranged to be at least indirectly driven by the engine, wherein the electrical generator furthermore is arranged to generate an electrical current when driven, wherein said electrical current at least indirectly is arranged to propel the fan motor.

2. The engine-driven tool according to claim 1, wherein the engine-driven tool comprises an electrical conductor arrangement that is arranged to at least indirectly connect the electrical generator to the fan motor.

3. The at engine-driven tool according to claim 2, wherein the electrical conductor arrangement partly is running inside the dust hose.

4. The engine-driven tool according to claim 2, wherein the electrical conductor arrangement is releasably connectable to the electrical generator and/or the electrically driven fan.

5. The engine-driven tool according to claim 4, wherein the electrical conductor arrangement is releasably connectable by at least one screw-mounted electrical connector.

6. The engine-driven tool according tool according to claim 1, wherein the engine-driven tool comprises a power transferring means that is arranged to connect the rotatable work tool to the engine.

7. The engine-driven tool according to claim 6, wherein the engine-driven tool comprises a dust pipe that is connected between an upper part of the shielding cover and a first hose end of the dust hose, wherein the dust pipe is arranged to extend over the power transferring means.

8. An engine-driven tool according to claim 1, wherein the electrical generator comprises circumferentially arranged coils and is co-axially arranged with an engine flywheel that comprises at least one circumferentially running magnet, wherein the engine flywheel is arranged to spin while the electrical generator is fixed in relation to the engine flywheel such that the magnets spin past the coils when the engine flywheel is rotating.

9. The engine-driven tool according to claim 6, wherein the electrical generator is arranged to be propelled by the power transferring means.
